(19) United States
(12) Patent Application Publication
(10) Pub. No.: US 2024/0311125 A1
(43) Pub. Date: Sep. 19, 2024

(54) DEEP LEANRING METHODS AND SYSTEMS FOR AUTOMATED APPLICATION UPDATING

(71) Applicant: BABU VINOD, Palo Alto, CA (US)

(72) Inventor: BABU VINOD, Palo Alto, CA (US)

(21) Appl. No.: 18/386,587

(22) Filed: Nov. 2, 2023

Related U.S. Application Data
(60) Provisional application No. 63/421,572, filed on Nov. 2, 2022.

(51) Int. Cl. G06F 8/65; G06F 8/41; G06F 16/955; G06F 21/30; G06F 40/30

(52) U.S. Cl. CPC G06F 8/65; G06F 8/427; G06F 16/9558; G06F 21/30; G06F 40/30

(57) ABSTRACT

In one aspect, a computerized method for automatically updating a legacy computer application comprising: providing an automated application update tool; providing a first database of identified application elements to be updated; providing a second database of updated application elements to replace the identified application elements to be updated; configuring the automated application update tool to: automatically log into a development environment used to update the legacy computer application; parse the computer application into a plurality of page elements; identify one or more legacy elements of each page of the plurality of page elements; identify each application elements to be updated extant on each page as provided in the first database of identified application elements to be updated; automatically replace each application elements to be updated with a corresponding second database of updated application elements to replace the identified application elements to be updated; and format an updated version of the computer application to replace the legacy computer application.

### CLAIM OF PRIORITY

This application claims priority to U.S. Provisional Patent Application No. 63/421,572, flied on Nov. 2, 2022, and titled METHODS AND SYSTEMS FOR AUTOMATED APPLICATION UPDATING. This provisional application is hereby incorporated by reference in its entirety.

### BACKGROUND

Employees of a company can have conference calls to discuss development of an application. The employees can draw out various application attributes and functions on a white board (e.g. physical and/or virtual whiteboard). However, in order to implement application development, the employees then need to manually convert the white board material, meeting notes, etc. into a format for an application developer to then use to manually build the application. Accordingly, computerized tools are needed to automat the collection of the information, the formatting of the information and the automated generation of the application (e.g. at least in a prototype form).

### SUMMARY OF THE INVENTION

In one aspect, a computerized method for automatically updating a legacy computer application comprising: providing an automated application update tool; providing a first database of identified application elements to be updated; providing a second database of updated application elements to replace the identified application elements to be updated; configuring the automated application update tool to: automatically log into a development environment used to update the legacy computer application; parse the computer application into a plurality of page elements; identify one or more legacy elements of each page of the plurality of page elements; identify each application elements to be updated extant on each page as provided in the first database of identified application elements to be updated; automatically replace each application elements to be updated with a corresponding second database of updated application elements to replace the identified application elements to be updated; and format an updated version of the computer application to replace the legacy computer application.

In another aspect, a method for automated application updating, comprising the steps of: obtain legacy application; parse application into page elements; analyze updatable legacy elements of the legacy application; identify legacy elements of each page; match found updatable legacy elements with current-version elements; remove updatable legacy elements and integrate current-version elements.

### BRIEF DESCRIPTION OF THE DRAWINGS

FIG. 1 illustrates an example process used for automated application updating, according to some embodiments.

FIG. 2 illustrates another example process used for automated application updating, according to some embodiments.

FIG. 3 illustrates an example automated application updating system, according to some embodiments.

FIG. 4 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for automated application updating. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application program is a computer program designed to carry out a specific task other than one relating to the operation of the computer itself, typically to be used by end-users.

App (application) store (e.g. an app marketplace) is a type of digital distribution platform for computer software called applications, often in a mobile context. Apps provide a specific set of functions which, by definition, do not include the running of the computer itself. Complex software designed for use on a personal computer, for example, may have a related app designed for use on a mobile device. Apps can be normally designed to run on a specific operating system-such as the contemporary iOS, macOS, Windows or Android—but in the past mobile carriers had their own portals for apps and related media content.

Deep learning is part of a broader family of machine learning methods based on artificial neural networks with representation learning. Learning can be supervised, semi-supervised or unsupervised.

Deep neural network (DNN) is an artificial neural network (ANN) with multiple layers between the input and output layers. There are different types of neural networks but they always consist of the same components: neurons, synapses, weights, biases, and functions.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Natural language processing, a branch of artificial intelligence concerned with automated interpretation and generation of human language.

Optical character recognition or optical character reader (OCR) is the electronic or mechanical conversion of images of typed, handwritten, or printed text into machine-encoded text, whether from a scanned document, a photo of a document, a scene-photo and/or from subtitle text superimposed on an image.

### Example Systems and Methods

Example systems can be used for modernization of an older version of an application to a modernized/contemporary version of the application in an automatic manner. The system can obtain a login ID, password, etc. to log into a develop mode and/or functionality of the application. The system can then log into the application development environment. The system can analyze the application page by page, understands what is on each page, and create a modern looking version of that page in parallel. The system can then click on each hyperlink navigate to the next page and repeats the same action. The system can modernize the application which is heavy on front end functionality in record time. In one example, the system an automatically modernize mainframe applications to web applications in little or no time.

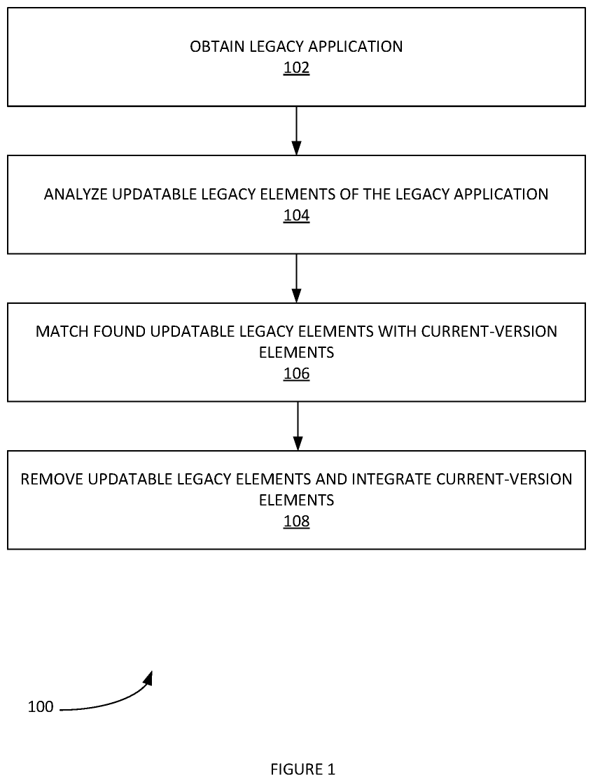

FIG. 1 illustrates an example process 100 used for automated application updating, according to some embodiments. In step 102, process 100 can obtain legacy application. In step 104, process 100 can analyze updatable legacy elements of the legacy application. In step 106, process 100 can match found updatable legacy elements with current-version elements. In step 108, process 100 can remove updatable legacy elements and integrate current-version elements.

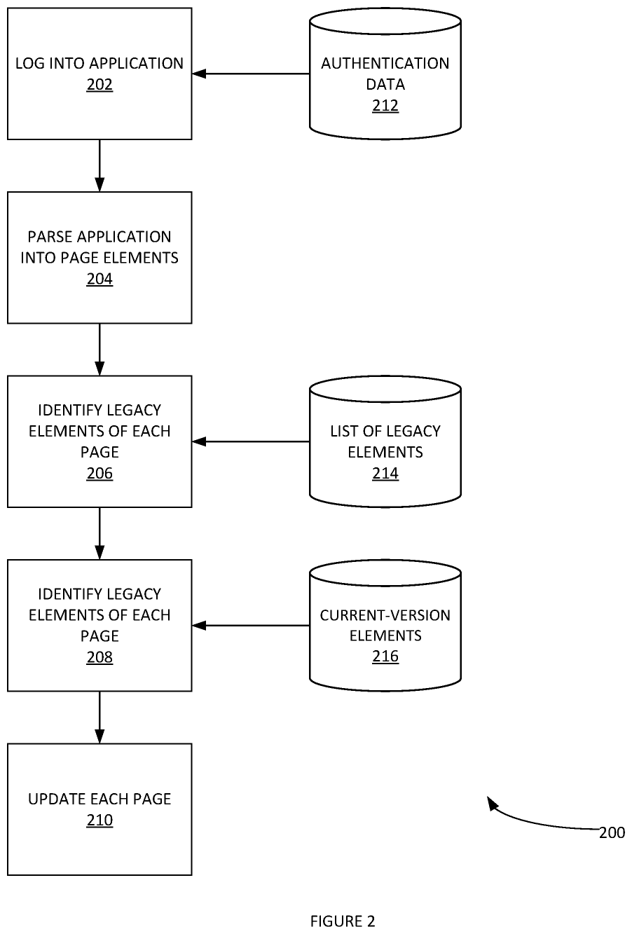

FIG. 2 illustrates another example process 200 used for automated application updating, according to some embodiments. In step 202, process 200 can log into application. In step 204, process 200 can parse application into page elements. In step 206, process 200 can perform authentication data. In step 208 process 200 can identify legacy elements of each page. Process 200 can utilize a list of legacy elements to identify the portions of application page to be replaced. Process 200 can use current-version elements as the replacement elements used to application page updates. Process 200 can be utilized with process 100 in whole and/or in part. Processes 100 and 200 can be implemented by systems 300 and 400 discussed infra.

### Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset. Processes 100 and 200 can take an idea and convert to a set of application on the fly. In some examples, applications can be created on the fly during the conference call while the users discuss it. In this way, users can iterate through various versions of the application and/or debug in real time (e.g. assuming networking and processing latencies, etc.). In this way, a conference call can be converted into a functioning application.

It is noted that a hierarchy of participants can be utilized (e.g. based on employment position, technical experience, etc.) where an automated application development process takes user contributions and applies them based on status of who suggests the contribution.

### Example Automated Application Development System

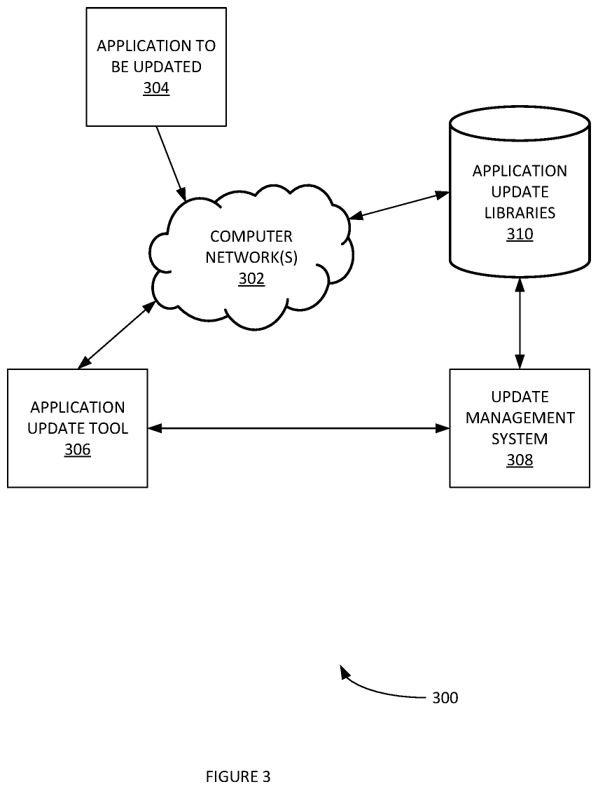

FIG. 3 illustrates an example automated application updating system 300, according to some embodiments. System 300 can include computer network(s) 302. The devices and sub-systems and/or other elements of system 300 can communicate via computer network(s) 302. System 300 can include an application 304 to be updated. An application update tool 306 can automatically log into application 304 and/or a development environment used to update application 304. Application update tool 306 can modernize of an older version of application 304 to a modern version of the application. Application update tool 306 be given a login ID and/or a password to log into a development environment/tool of application 304. Application update tool 306 go page by page.

Application update tool 306 can use various computer functionalities (e.g. ML, natural language understanding, etc.) to understand the content of each application page. Application update tool 306 creates a modern looking version of that application page in parallel.

Application update tool 306 can then click on each link goes to the next page and repeats the same action. Application update tool 306 effectively modernizes the application which is heavy on front end functionality in record time. In this way, a mainframe application(s) can be modernized to a web application(s) in little or no time in an automatic manner. Automated application updating tool 306 implement processes 100 and 200.

Automated application updating tool 306 can include various functionalities such as, inter alia: OCR, NLP, databases, application editing tools, application design editors, ML/AI development systems, etc. Automated application updating tool 306 can use 3^{rd} party systems as well (e.g. geolocation systems, geofencing system, geo-mapping systems, multimedia databases, language databases, e-commerce servers, etc.).

Application update libraries 314 can be maintained based on the types of application designs, attributes, and functionalities that an enterprise may need/use. Application update libraries 314 can include various application templates. Application update libraries 314 can include pre-generated and tested/debugged functionalities/attributes. In this way, functionalities/attributes are able of being automatically integrated into the application merely based on the analysis of the input into process 100. Applications generated by system 300 can be published to application store(s) 312. Application store(s) can be proprietary within the enterprise (e.g. only available to employees, etc.) and/or public app stores.

System 300 can maintain a database of application update libraries 310. Application update libraries 310 can include authentication data, list of legacy elements, current-version elements, etc. Update management system 308 can maintain the content of application update libraries 310 and/or communicate this content to automated application updating tool 306.

### Additional Example Computer Architecture and Systems

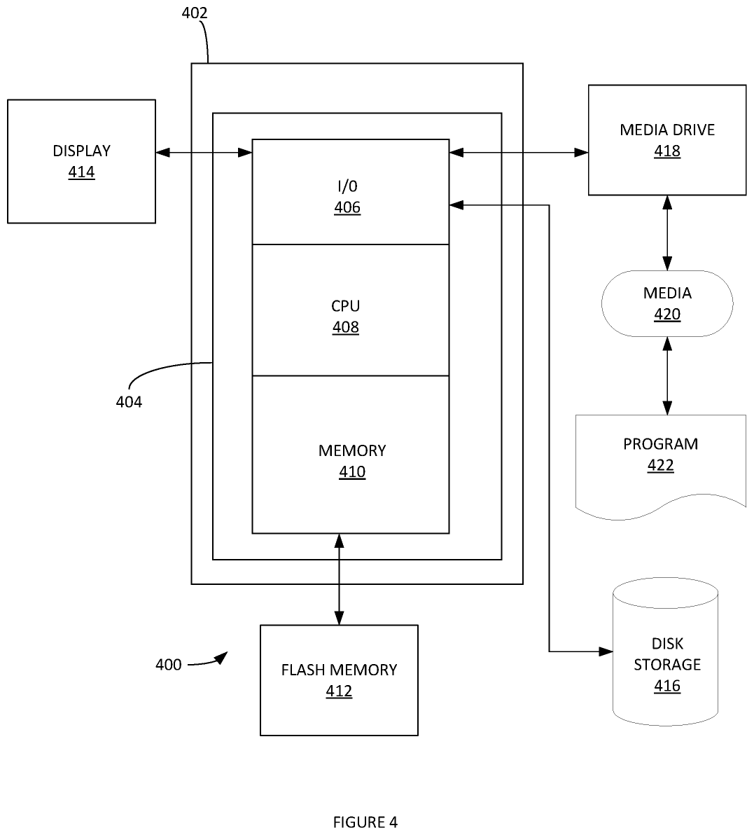

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The 1/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

In one aspect, a computerized method for automatically updating a legacy computer application comprising: providing an automated application update tool; providing a first database of identified application elements to be updated; providing a second database of updated application elements to replace the identified application elements to be updated; configuring the automated application update tool to: automatically log into a development environment used to update the legacy computer application; parse the computer application into a plurality of page elements; identify one or more legacy elements of each page of the plurality of page elements; identify each application elements to be updated extant on each page as provided in the first database of identified application elements to be updated; automatically replace each application elements to be updated with a corresponding second database of updated application elements to replace the identified application elements to be updated; and format an updated version of the computer application to replace the legacy computer application.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method for automatically updating a legacy computer application comprising:
providing an automated application update tool;
providing a first database of identified application elements to be updated;
providing a second database of updated application elements to replace the identified application elements to be updated;
configuring the automated application update tool to:
automatically log into a development environment used to update the legacy computer application;
parse the computer application into a plurality of page elements;
identify one or more legacy elements of each page of the plurality of page elements;
identify each application elements to be updated extant on each page as provided in the first database of identified application elements to be updated;
automatically replace each application elements to be updated with a corresponding second database of updated application elements to replace the identified application elements to be updated; and
format an updated version of the computer application to replace the legacy computer application.

2. The computerized method of claim 1 further comprising:
configuring the automated application update tool to publish updated version of the computer application to a web-based service.

3. The computerized method of claim 2, wherein the application update tool comprises a password to the development environment.

4. The computerized method of claim 3, wherein the automatic application update tool uses a hyperlink on a first page of the computer application to access a subsequent page of the computer application.

5. The computerized method of claim 4, wherein the wherein the automatic application update tool uses a natural language processing algorithm to determine an understanding of a content of each page of the computer application.

6. The computerized method of claim 5, wherein the automatic application update tool uses a machine learning functionality to optimize the understanding of the content of each page of the computer application.

7. The computerized method of claim 6, wherein the automatic application update tool creates a modern looking version of each computer application page.

8. A method for automated application updating, comprising the steps of:
obtain legacy application;
parse application into page elements;
analyze updatable legacy elements of the legacy application;
identify legacy elements of each page;
match found updatable legacy elements with current-version elements;
remove updatable legacy elements and integrate current-version elements.

9. The method of claim 8 further comprising:
utilize a list of legacy elements to identify the portions of application page to be replaced.

10. The method of claim 9 further comprising:
use current-version elements as the replacement elements used to application page updates.

11. The method of claim 10, wherein the application comprises a mobile-device application.

12. The method of claim 11, wherein the application comprises a web-based application.
